(19) United States
(12) Patent Application Publication
(10) Pub. No.: US 2026/0089519 A1
(43) Pub. Date: Mar. 26, 2026

(54) ANCHOR CHANNEL FOR UPPER 6 GHZ BAND SHARING

(71) Applicant: QUALCOMM Incorporated, San Diego, CA (US)

(72) Inventors: Chih-Hao LIU, San Diego, CA (US); Aleksandar DAMNJANOVIC, Del Mar, CA (US); Yisheng XUE, San Diego, CA (US); Xiaoxia ZHANG, San Diego, CA (US); Jing SUN, San Diego, CA (US)

(21) Appl. No.: 18/893,861

(22) Filed: Sep. 23, 2024

(51) Int. Cl. H04W 24/04; H04L 5/14; H04W 68/02; H04W 72/0457

(52) U.S. Cl. CPC H04W 24/04; H04L 5/1469; H04W 68/02; H04W 72/0457

(57) ABSTRACT

A method for wireless communication at a user equipment (UE) and related apparatus are provided. In the method, the UE performs an initialization or maintenance procedure with a network entity for a first radio access technology (RAT) using at least one anchor channel based on a configuration of one or more anchor channels for the first RAT. The one or more anchor channels are distributed in a frequency band shared between the first RAT and a second RAT. The UE further communicates on the frequency band using one or more of the first RAT or the second RAT. The first RAT has priority over the second RAT for using the one or more anchor channels.

### TECHNICAL FIELD

The present disclosure relates generally to communication systems and, more particularly, to the use of anchor channels for band sharing among different radio access technologies in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to perform, with a network entity, an initialization or maintenance procedure for a first radio access technology (RAT) using at least one anchor channel based on a configuration of one or more anchor channels for the first RAT, where the one or more anchor channels are distributed in a frequency band shared between the first RAT and a second RAT; and communicate on the frequency band using one or more of the first RAT or the second RAT, where the first RAT has priority over the second RAT for using the one or more anchor channels.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, to a UE, a configuration for an allocation of one or more anchor channels for a first RAT, where the one or more anchor channels are distributed in a frequency band shared between the first RAT and a second RAT; perform an initialization or maintenance procedure based on the first RAT using at least one anchor channel from the one or more anchor channels; and communicate with the UE on the frequency band, wherein the first RAT has priority over the second RAT for using the one or more anchor channels.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of cross technology signaling with multiple radio access technologies (RATs).

FIG. 5 is a call flow diagram illustrating an example of cross technology signaling.

FIG. 6 is a diagram illustrating an example of using anchor channels for cross technology signaling in accordance with various aspects of the present disclosure.

FIG. 7 is a diagram illustrating example anchor channel locations in accordance with various aspects of the present disclosure.

FIG. 8 is a diagram illustrating example anchor channels and Wi-Fi primary channels in accordance with various aspects of the present disclosure.

FIG. 9 is a diagram illustrating an example of cross technology signaling using one or more anchor channels in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a flowchart illustrating methods of wireless communication at a network entity in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In wireless communication, cross technology signaling enables devices to utilize multiple radio access technologies (RATs) on the same frequency band. For example, the upper 6 GHz band may be allocated for indoor Wi-Fi use and outdoor deployments by cellular networks, such as 5G networks. In cellular communication, synchronization signals such as the synchronization signal block (SSB) and system information block (SSB) are transmitted and received periodically, and user equipment (UE) relies on these synchronization signals for synchronization, radio link monitoring (RLM), and cell reselection. To prevent interference from other RATs, such as Wi-Fi, while still allowing shared bandwidth, the bandwidth part (BWP) allocated for these signals needs to be protected from interference from other RATs. Example aspects presented herein provide methods and apparatus for using anchor channels to facilitate band sharing among various RATs.

Various aspects relate generally to wireless communication. Some aspects more specifically relate to the use of anchor channels for band sharing among different radio access technologies in wireless communication. In some examples, a UE performs an initialization or maintenance procedure with a network entity for a first radio access technology (RAT) using at least one anchor channel based on the configuration of one or more anchor channels for the first RAT. The one or more anchor channels may be distributed in a frequency band shared between the first RAT and a second RAT. The UE further communicates on the frequency band using one or more of the first RAT or the second RAT, and the first RAT may have priority over the second RAT for using the one or more anchor channels. In some examples, the frequency band may include a frequency of 6 GHz. In some examples, the frequency band may include bands lower than 6 GHz or higher than 6 GHz. In some examples, the initialization or maintenance procedure may include transmitting or receiving a synchronization signal based on the first RAT, transmitting, receiving, or monitoring for a random access channel (RACH) message based on the first RAT, or transmitting, receiving, or monitoring for a paging signal based on the first RAT. In some examples, the first RAT may be for wireless cellular communication, and the second RAT may be for Wi-Fi communication.

Particular aspects of the subject matter described in this disclosure can be implemented to realize one or more of the following potential advantages. In some examples, by designating specific channels in a frequency band, such as the upper 6 GHz band, as anchor channels, the described techniques ensure that important signals for one RAT, such as synchronization, RACH, and paging signals, are transmitted without interference from signals from another RAT, such as Wi-Fi, thereby improving the reliability and quality of service in wireless communication. In some examples, by structuring spectrum usage to allow different RATs to operate on adjacent or non-overlapping channels, the described techniques facilitate the coexistence of various RATs, such as wireless cellular communication and Wi-Fi, enhancing the overall performance of wireless communication. In some examples, by allowing for dynamic configuration of anchor channels based on real-time network conditions, the described techniques improve the flexibility and reliability of resource utilization in wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

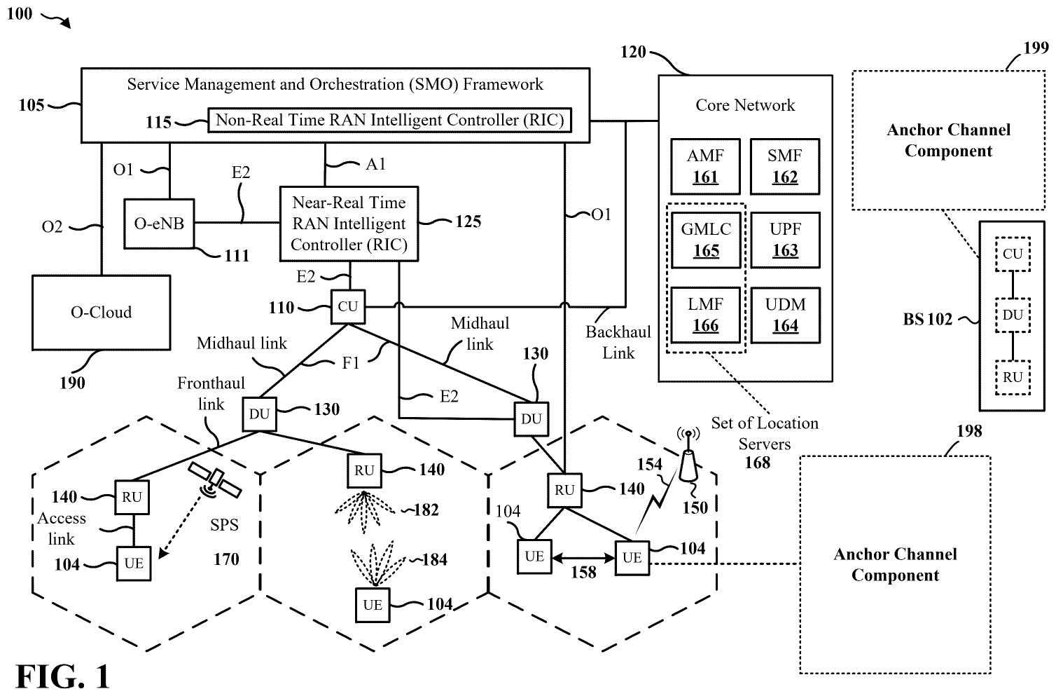

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an anchor channel component 198. The anchor channel component 198 may be configured to perform, with a network entity, an initialization or maintenance procedure for a first radio access technology (RAT) using at least one anchor channel based on a configuration of one or more anchor channels for the first RAT, where the one or more anchor channels are distributed in a frequency band shared between the first RAT and a second RAT; and communicate on the frequency band using one or more of the first RAT or the second RAT. The first RAT may have priority over the second RAT for using the one or more anchor channels. In certain aspects, the base station 102 may include an anchor channel component 199. The anchor channel component 199 may be configured to transmit, to a UE, a configuration for an allocation of one or more anchor channels for the first RAT, where the one or more anchor channels are distributed in a frequency band shared between the first RAT and a second RAT; perform an initialization or maintenance procedure based on the first RAT using at least one anchor channel from the one or more anchor channels; and communicate with the UE on the frequency band, where the first RAT has priority over the second RAT for using the one or more anchor channels. Although the following description may be focused on 5G NR, the concepts described herein may be applicable to other similar areas, such as LTE, LTE-A, CDMA, GSM, and other wireless technologies.

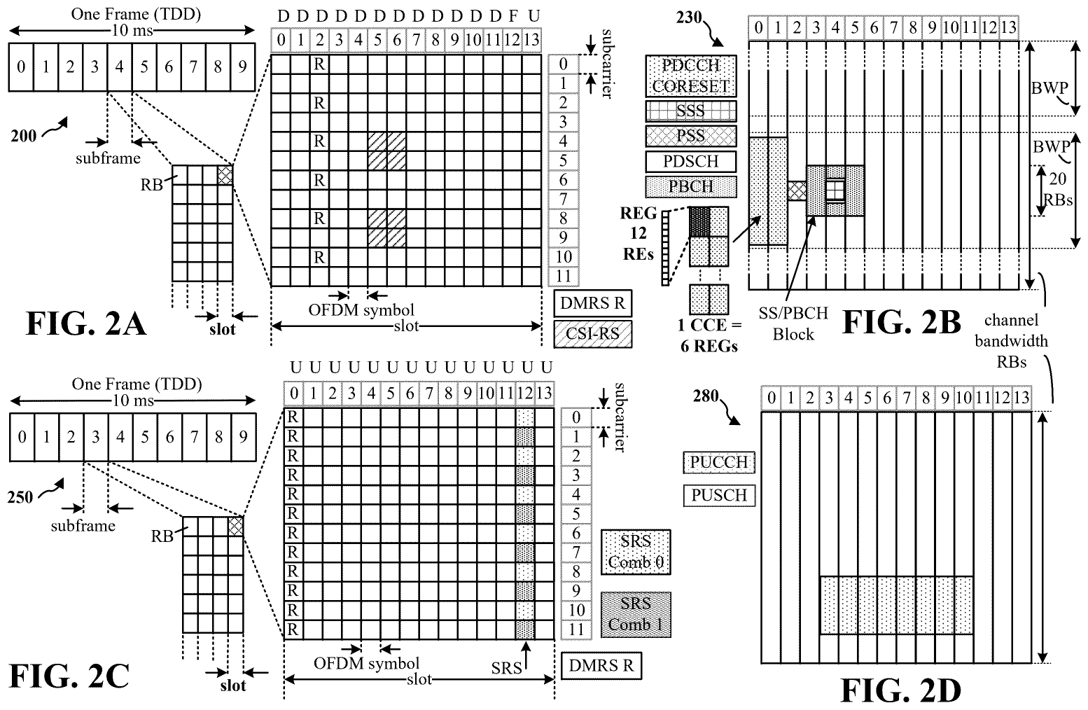

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal. |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

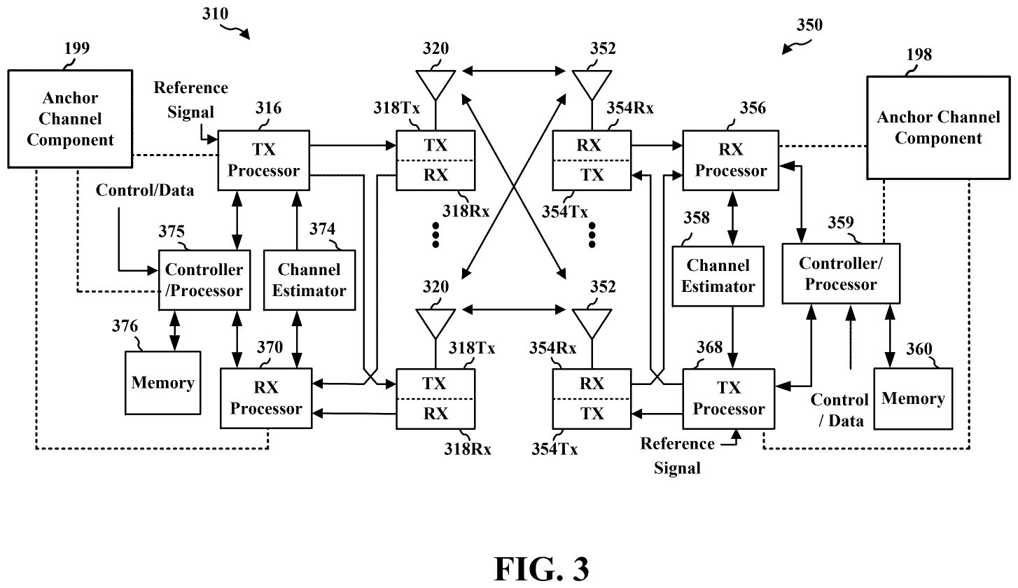

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the anchor channel component 198 of FIG. 1.

At least one of the TX processor 316, the RX processor 370, and the controller/processor 375 may be configured to perform aspects in connection with the anchor channel component 199 of FIG. 1.

The present disclosure provides methods and apparatus for implementing an anchor channel for band sharing within a frequency band, including the upper 6 GHz spectrum. The signals transmitted on the anchor channel for one radio access technology (RAT), such as RACH messages or paging occasions (PO), are protected from interference by signals from another RAT, e.g., Wi-Fi. Some aspects of the disclosure define the anchor channel, and some aspects provide a mechanism for the network to signal the anchor channel to an access point (AP) through an authentication server (AS). Additionally, some aspects specify the behaviors of Wi-Fi nodes, and some aspects enable the network's ability to indicate the synchronization instances, RACH opportunities (RO), or PO instances to the AS.

In wireless communication, cross technology signaling enables devices to utilize multiple RATs on the same frequency band. For example, the upper 6 GHz band may be allocated for indoor Wi-Fi use and outdoor deployments by cellular networks, such as 5G networks. In cellular communication, synchronization signals such as the SSB and SSB are transmitted and received periodically, and UE relies on these synchronization signals for synchronization, RLM, and cell reselection. To prevent interference from other RATs (e.g., Wi-Fi), while still allowing shared bandwidth, the BWP allocated for these signals need to be protected from interference from other RATs. Example aspects presented herein provide methods and apparatus for using anchor channels to facilitate band sharing among various RATs.

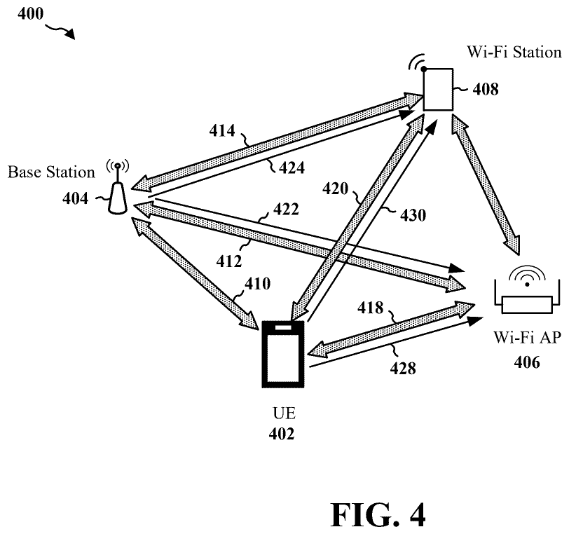

FIG. 4 is a diagram 400 illustrating an example of cross technology signaling with multiple RATs. In FIG. 4, a base station for a cellular network, such as a 5G network, and UE may utilize Wi-Fi waveforms for cross technology signaling. For example, a base station 404 may communicate with a UE 402 via a cellular network (e.g., 5G network). At the same time, the base station 404 may connect to a Wi-Fi access point (AP) 406 through interface 412 and to a Wi-Fi station 408 through interface 414. These interfaces (e.g., interfaces 412, 414) enable the base station 404 to communicate with the Wi-Fi AP 406 at 422 and the Wi-Fi station 408 at 424 using cross technology signaling. For example, the base station 404 may use discontinuous transmission (DTX) during designated “D” slots to send cross technology signals to the Wi-Fi AP 406 at 428 or the Wi-Fi station 408 at 424, without the need for listen before talk (LBT) procedures. In some examples, the UE 402 may, while maintaining a connection with the base station 404, establish interface 420 with the Wi-Fi station 408 and interface 418 with the Wi-Fi station 408. Based on these interfaces (e.g., interfaces 418, 420), the UE may communicate with the Wi-Fi AP 406 and the Wi-Fi station 408 using cross technology signaling. For example, the UE 402 may utilize dual subscriber identity module (SIM) single active (DSSA) gaps to periodically “tune out” from their primary activities (e.g., the communication with the base station 404 via 410) and transmit cross technology signals to Wi-Fi AP 406 at 428 or to Wi-Fi station 408 at 430. In some examples, when a UE 402 is connected to another carrier frequency with a base station, the UE 402 may utilize dynamic capability signaling suitable for scenarios involving dual SIM dual active (DSDA) configurations.

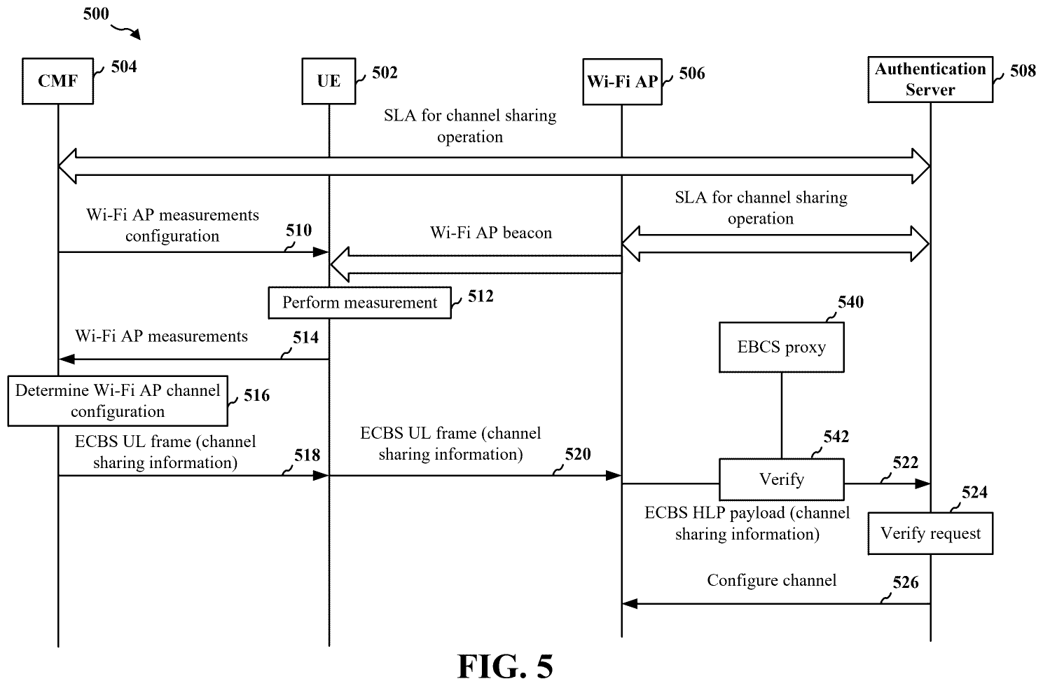

FIG. 5 is a call flow diagram 500 illustrating an example of cross technology signaling. In FIG. 5, the channel management function (CMF) 504 may, at 510, configure UE 502 to measure Wi-Fi signals. In some examples, the CMF 504 may include a system network function for wireless communication. In some examples, the operations, administration, and maintenance (OAM) function may take the role of CMF, and the OAM may configure the radio access network (RAN) node. The RAN node may configure the UE 502 to perform Wi-Fi signal measurements through RRC signaling.

Once the UE 502 has measured the Wi-Fi signals (at 512), the UE 502 may, at 514, report back to the CMF 504 or to the RAN node, depending on the setup. The CMF 504 may then, at 516, determine the appropriate Wi-Fi channel configuration and construct channel sharing information. The CMF 504 may, at 518, transmit the channel sharing information back to the UE 502, and the UE 502 then, at 520, forwards it to the Wi-Fi Access Point (AP) 506. Subsequently, the Wi-Fi AP 506 may, at 522, transmit this channel sharing information to its intended destination (e.g., the authentication server 508) via an enhanced broadcast services (EBCS) proxy 540. The EBCS proxy 540 may verify the EBCS uplink frame at 542.

The authentication server 508 may, at 524, verify the channel sharing information. In some examples, the authentication server 508 may be managed by a mobile network operator (MNO), a broadband operator, or an enterprise. Following the verification at 524, the authentication server 508 may, at 526, configure the AP channel for the Wi-Fi AP 506 (assuming there exists a secure link between the Wi-Fi AP 506 and the authentication server 508). In some examples, multiple APs in the domain server (DS) may to be configured simultaneously by the authentication server 508. Upon receiving the AP channel configuration from the authentication server 508 (at 526), the Wi-Fi AP 506 may apply the AP channel configuration for cross technology signaling.

In wireless communication, including in 5G or 6G networks, synchronization signals such as SSB and SIB are transmitted and received periodically. UEs rely on these synchronization signals for synchronization, RLM, and cell reselection to ensure reliable and uninterrupted service. Hence, the initial BWP for these signals needs to be protected from interference from other RATs (e.g., Wi-Fi signals), while still allowing for the possibility of a wider BWP sharing bandwidth with these RATs (e.g., Wi-Fi). Additionally, the random access channel (RACH) messages (e.g., MSG1, MSG2, MSG3, and MSG4) and the paging occasion (POs) for monitoring paging messages when the UE in idle mode is also susceptible to interference from other RATs (e.g., Wi-Fi signals) and need to be protected. Example aspects presented herein provide methods and apparatus for using anchor channels to facilitate band sharing among various RATs. In the example aspects presented herein, various RATs may include the first RAT and the second RAT. As an example, the first RAT may include cellular communications or IMT communication, and the second RAT may include Wi-Fi communication.

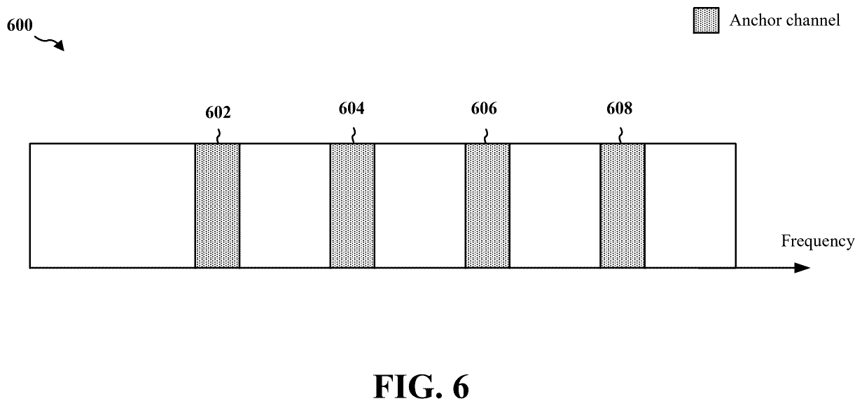

FIG. 6 is a diagram 600 illustrating an example of using anchor channels for cross technology signaling in accordance with various aspects of the present disclosure. As shown in FIG. 6, one or more anchor channels, such as anchor channels 602, 604, 606, 608, may be provided within a frequency range, such as the upper 6 GHz band, to manage interference between different RATs. For example, these anchor channels may protect the signals of international mobility telecommunication (IMF) from interference from Wi-Fi. In some examples, the anchor channels (e.g., anchor channels 602, 604, 606, 608) may be used for signals to be protected, such as synchronization signals, RACH signals, and paging signals, and the signals from other RATs (e.g., Wi-Fi) may not use these anchor channels. For example, a UE may use the anchor channels to transmit or receive the synchronization signal, transmit, receive, or monitor for a RACH message, or transmit, receive, or monitor for a paging signal (or paging message). These anchor channels may be used for the initial BWP, ensuring that these signals are transmitted without interference from other RATs, such as Wi-Fi.

In some aspects, each of these anchor channels (e.g., anchor channels 602, 604, 606, 608) may have a bandwidth of at least 20 MHz, matching the typical LBT bandwidth and Wi-Fi channel width bandwidth, which may align with 20 MHz. In some examples, the bandwidth allocation of 20 MHz for each anchor channel may exceed the frequency bandwidth for 20 resource block (RB) synchronization signal block (SSB) and the 24RB default BWP for subcarrier spacing (SCS) of 15/30/60 KHz, thus providing ample frequency range for transmitting the important signals for wireless communication, such as the synchronization signal, RACH messages, or paging signals or messages.

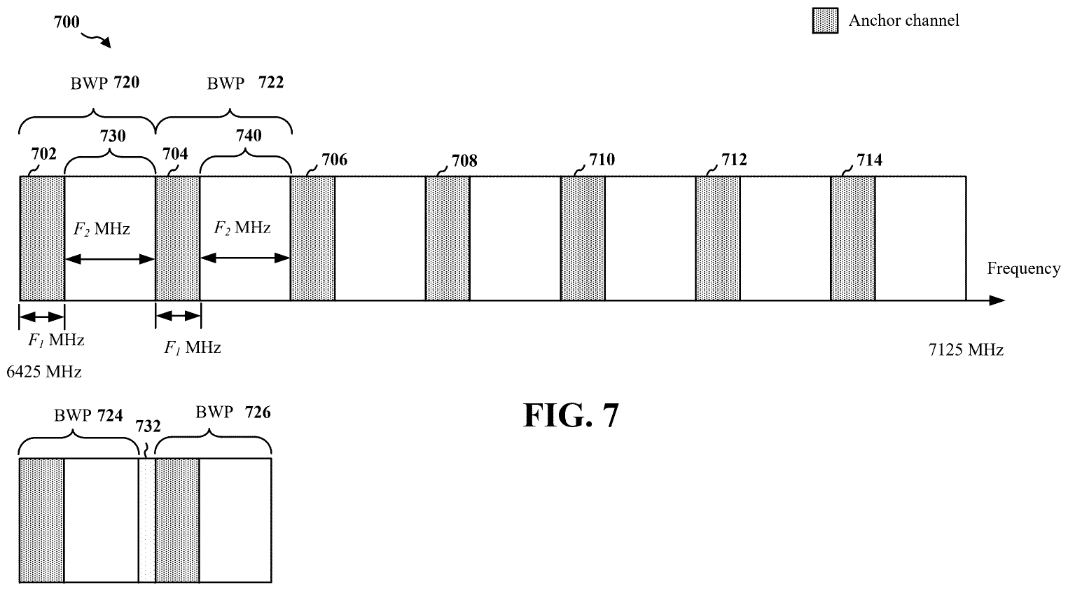

FIG. 7 is a diagram 700 illustrating example anchor channel locations in accordance with various aspects of the present disclosure. As shown in FIG. 7, in the upper 6 GHz band, such as a frequency band spanning from a lower limit (e.g., 6425 MHz) to an upper limit (e.g., 7125 MHz), each Wi-Fi channel may occupy a unit frequency range, such as 20 MHz, and continuous channels may be bonded to form wider channels of 40, 80, 160, or 320 MHz to support higher data throughput, with one of the 20 MHz channels may be designated as the primary channel. To facilitate efficient use of the spectrum and allow for Wi-Fi channel bonding, the anchor channels (e.g., anchor channels 702, 704, 706, 708, 710, 712, 714) may be positioned to be evenly distributed across the band, with spacing designed to accommodate the bonded Wi-Fi channels of varying widths. In some aspects, each bandwidth part (BWP) configuration may include one anchor channel and an adjacent frequency band with a designated bandwidth. For example, the configuration for BWP 720 may include anchor channel 702 (with a bandwidth of F₁ MHz (e.g., 20 MHz)) and the adjacent frequency band 730 with the designated bandwidth of F₂ MHz (e.g., 80 MHz), and the configuration for BWP 722 may include anchor channel 704 (with a bandwidth of F₁ MHz) and the adjacent frequency band 740 with the designated bandwidth of F₂ MHz. In the example in FIG. 7, there are seven 20 MHz anchor channels (e.g., anchor channels 702, 704, 706, 708, 710, 712, 714) uniformly distributed with 80 MHz gaps between them.

In some aspects, to minimize inter-cell interference in scenarios involving NR or 6G technologies deployments from different network operators, two operators may have synchronous time division duplexing (TDD) and co-sited deployments by operators. For example, the first BWP associated with the first operator and the second BWP associated with the second operator may have synchronous TDD or the first BWP and the second BWP may be associated with the same RU. In some examples, smaller BWPs may be configured, which allows adequate guard bands (e.g., carrier gaps) to be configured between carriers from different operators. For example, a 90 MHz BWP (instead of 100 MHz), such as BWP 724, 726, may be configured to ensure a 10 MHz gap (e.g., guard band 732) between BWPs of different carriers. In some aspects, the base station and UE may implement filters to reduce potential interference.

With the implementation of one or more anchor channels (e.g., anchor channels 702, 704, 706, 708, 710, 712, 714) for the first RAT (e.g., cellular communication), the frequency bandwidth available for the second RAT (e.g., Wi-Fi) may be limited. For example, Wi-Fi may be limited to deployment in the 80 MHz spaces (e.g., 730) that exist between the 20 MHz anchor channels (e.g., anchor channels 702, 704). Such placements of the anchor channel ensure that while the anchor channels provide a protected spectrum for the first RAT (e.g., IMT communications), other RATs (e.g., Wi-Fi) can still operate efficiently within the same band, albeit with slightly reduced maximum channel widths.

In some aspects, the anchor channels may function as a hard partition for the first RAT (e.g., IMT communication) and may not be used by other RATs (e.g., Wi-Fi) even when the first RAT (e.g., IMT communication) is not active. This ensures that important signals from the first RAT, such as synchronization, RACH, and paging signals, are protected from any potential interference from other RATs.

In some aspects, using the cross technology sharing architecture, mobile network operators (MNOs) or base stations (e.g., gNBs) of the first RAT may signal the anchor channel information to the entities associated with other RATs, such as an authentication server (AS) associated with the second RAT (e.g., Wi-Fi). For example, the base station for the first RAT may signal the selected anchor channels to the AS associated with the second RAT (e.g., Wi-Fi), which may then instruct the access points (APs) to avoid using these channels. This coordination may be governed by a service level agreement (SLA), which may define the available channels (or frequency bands) that can be used as anchor channels and the maximum number of anchor channels. Based on this information (e.g., available channels (frequency bands) for anchor channels and maximum number of anchor channels), the MNO may configure the anchor channels to the base station for synchronization signals, RACH messages, paging signals or messages, or initial BWP accordingly,

In some aspects, the MNO or base station associated with the first RAT may, based on the SLA, signal the selected anchor channels along with their geographical locations to the AS. The AS then may configure the APs to refrain from using these anchor channels if an AP is geographically proximate to the specified locations or if the AP's location is unknown.

In some aspects, if the second RAT is Wi-Fi, the primary channels for Wi-Fi may be configured to avoid overlapping with statically or dynamically configured anchor channels used for the first RAT (e.g., IMT operations). This strategy ensures that Wi-Fi nodes continue to operate effectively on their primary channel even when the first RAT (e.g., IMT operations) are actively using the anchor channels for basic communications like synchronization and paging signals.

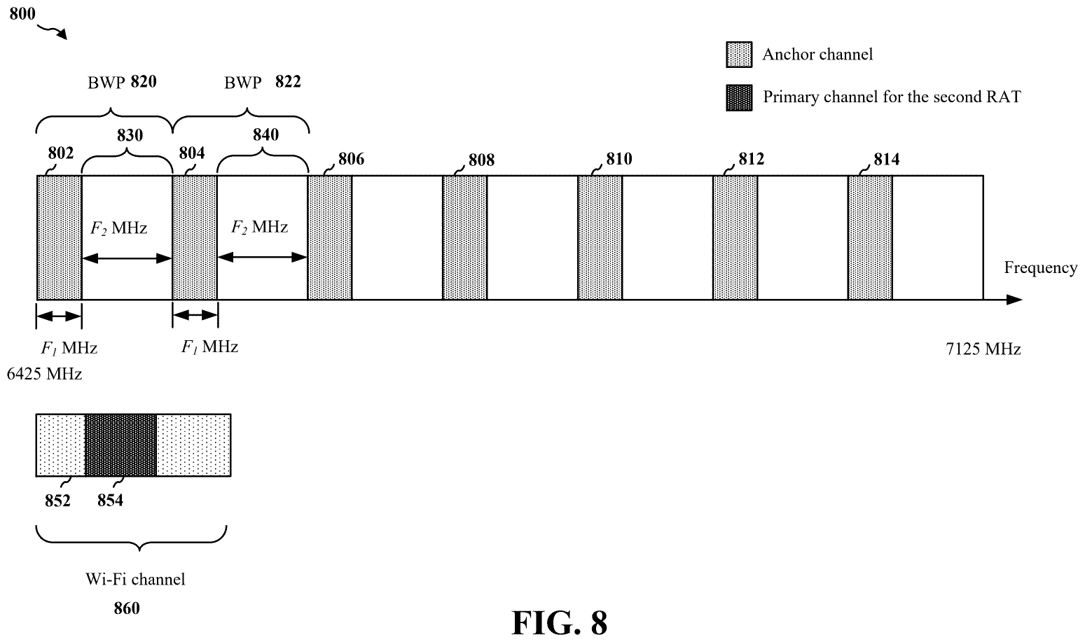

FIG. 8 is a diagram 800 illustrating example anchor channels and Wi-Fi primary channels in accordance with various aspects of the present disclosure. As shown in FIG. 8, one or more anchor channels (e.g., anchor channels 802, 804, 806, 808, 810, 812, 814) may be configured over the frequency band. In some examples, a first BWP 820 may be configured (e.g., via a BWP configuration) for the first RAT, and the first BWP 820 may include a first anchor channel 802 of the one or more anchor channels and a frequency space 830 adjacent to the first anchor channel 802. In some examples, a second BWP 822 may be configured (e.g., via a BWP configuration) for the first RAT, and the second BWP 822 may include a second anchor channel 804 of the one or more anchor channels different from the first anchor channel 802 and a frequency space 840 adjacent to the second anchor channel 804. In some examples, the first communication associated with the first BWP and the second communication associated with the second BWP may have a synchronous TDD. In some examples, the first BWP and the second BWP may be associated with the same RU.

In some examples, the entities associated with the second RAT (e.g., Wi-Fi nodes) may avoid selecting the configured anchor channels (e.g., anchor channels 802, 804, 806, 808, 810, 812, 814) when selecting their primary channels (e.g., primary channel 854) in the communication channel 860. In some examples, the anchor channels may be hard-coded in the Wi-Fi nodes. In some examples, the information of the anchor channels may be dynamically signaled to the Wi-Fi nodes via an authentication server. When the Wi-Fi nodes avoid selecting these anchor channels as their primary channels (e.g., primary channel 854), the Wi-Fi channel that overlaps with an anchor channel (e.g., 20 MHz), such as Wi-Fi channel 852 may not be utilized independently. This setup ensures the coexistence of different RATs (e.g., Wi-Fi and IMT operations) by segregating the primary operational channels of both technologies. Thus, even with anchor channels being configured for basic operations for the first RAT (e.g., basic IMT operations), the second RAT (e.g., Wi-Fi) may still function efficiently on its primary channels, effectively orthogonalizing the primary channel usage for the second RAT (e.g., Wi-Fi) from the initial BWP of the first RAT (e.g., the IMT operations).

In some aspects, the second RAT (e.g., Wi-Fi) may be given priority over the first RAT (e.g., IMT communication) in using the frequency band, and the primary channel for the second RAT (e.g., Wi-Fi) may be protected from the interference from the first RAT (e.g., IMT communication). In this case, the nodes for the second RAT (e.g., Wi-Fi nodes) may signal the preferred channels to an authentication server, and the MNOs of the first RAT may ensure that these preferences are considered before choosing the anchor channels for the first RAT.

For example, the service level agreement (SLA) may define the available channels that can potentially be used as anchor channels and the maximum number of anchor channels, and the MNO of the first RAT may check with the AS or other entities associated with the second RAT to determine the preferred channels. The MNO or base station of the first RAT may then select the anchor channels that minimize interference with these preferred channels. For example, when multiple APs of the second RAT have indicated a preference for one channel, the MNO may avoid designating this one channel as an anchor channel, particularly if these APs are located within the same geographic area. In some examples, following the selection of the anchor channels, the MNO or base station of the first RAT may signal the selected anchor channels and their geographic specifics to the AS of the second RAT. The AS then may configure the APs to avoid selecting these anchor channels if the APs are near the specified locations or if their exact positions are unknown.

In some aspects, in scenarios where UEs are idle or inactive within a cell, the nodes of the second RAT (e.g., Wi-Fi nodes) may utilize the anchor channels for the first RAT. For example, when the APs of the second RAT are synchronized, via global positioning system (GPS) or cross technology signaling mechanisms with the entities of the first RAT, and synchronization signals, random access occasions (RO), and paging occasions (PO) are configured to transmit at periodic intervals, the second RAT (e.g., Wi-Fi nodes) may utilize the anchor channels for the first RAT.

In some aspects, the base station for the first RAT may signal the synchronization instances, RO, and PO instances to the authentication server of the second RAT. For example, the base station may indicate the period and offset for each of the synchronization instances, RO, and PO instances to the AS, and the AS may reconfigure the APs to avoid using those protected anchor instances for the second RAT.

In some aspects, for SSB and periodic SIB, the AP may configure the AS to mute synchronized Wi-Fi nodes during these periodic instances to prevent interference. In some aspects, for dynamic SIB instances, the UE may send cross technology signaling to the AP to indicate the dynamic SIB before requesting the SIB or before the base station schedules the dynamic SIB to prevent interference to the SIB. This signaling scheme may be implemented by the base station or the UE.

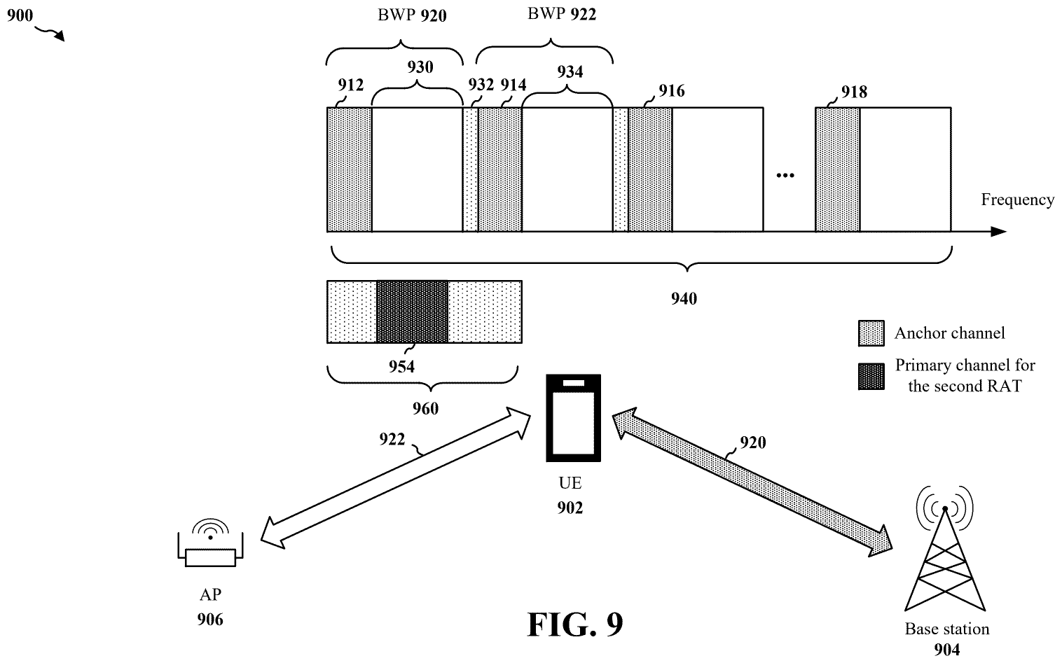

FIG. 9 is a diagram 900 illustrating an example of cross technology signaling using one or more anchor channels in accordance with various aspects of the present disclosure. In FIG. 9, a UE 902 may communicate, via 920, with a base station 904 using the first RAT, such as IMT communication or cellular communication, and with an AP 906 via 922 using the second RAT, such as Wi-Fi communication. One or more anchor channels (e.g., anchor channels 912, 914, 916, 918) may be configured on the frequency band 940. In some examples, these anchor channels (e.g., anchor channels 912, 914, 916, 918) may be uniformly distributed over the frequency band 940. These anchor channels may be reserved for communicating certain signals with the base station 904. For example, these signals may include synchronization signals, RACH messages, and paging signals. These anchor channels (e.g., anchor channels 912, 914, 916, 918) will not be used by the second RAT and hence the signals transmitted over these anchor channels are protected from any potential interference from the second RAT. In some examples, the initial BWP 920 for the first RAT may include one anchor channel of these anchor channels (e.g., anchor channel 912) and the frequency band 930 adjacent to the one anchor channel 912. In some examples, a first BWP 920 may be configured (e.g., via a BWP configuration) for the first RAT, and the first BWP 920 may include a first anchor channel 912 of the one or more anchor channels and a frequency band 930 adjacent to the first anchor channel 912. In some examples, a second BWP 922 may be configured (e.g., via a BWP configuration) for the first RAT, and the second BWP 922 may include a second anchor channel 914 of the one or more anchor channels different from the first anchor channel 912 and a frequency space 934 adjacent to the second anchor channel 914. In some examples, a guard band 932 may be provided between the first BWP 920 and the second BWP 922. In some examples, the first communication associated with the first BWP and the second communication associated with the second BWP may have a synchronous TDD.

In some examples, to coordinate the resource allocation between the first RAT and the second RAT, the entity of the second RAT, such as an AS for the second RAT, may be configured with the information of the one or more anchor channels (e.g., anchor channels 912, 914, 916, 918), and the resources for the second RAT may be allocated based on this information. For example, in the resources 960 configured for the second RAT, the primary channel 954 may be configured to avoid overlapping with the anchor channels (e.g., anchor channels 912, 914, 916, 918).

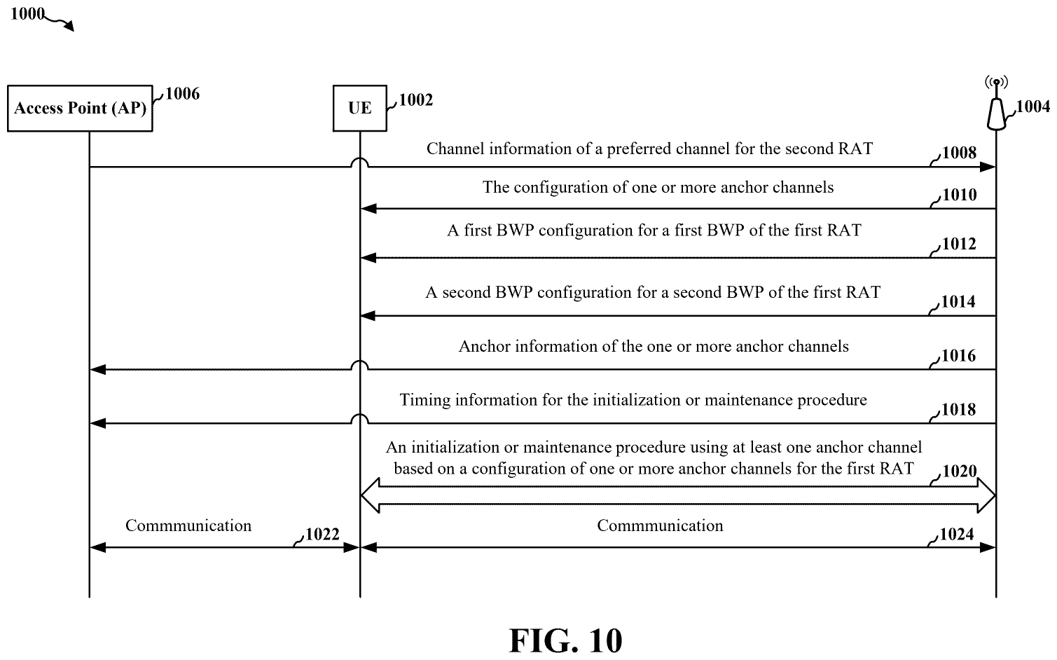

FIG. 10 is a call flow diagram 1000 illustrating a method of wireless communication in accordance with various aspects of this present disclosure. Various aspects are described in connection with a UE 1002, a first network entity associated with a first RAT (e.g., the IMT), and a second network entity associated with a second RAT (e.g., Wi-Fi). As an example, the first network entity may be a base station 1004 or one or more components of the base station 1004 (e.g., a CU 110, a DU 130, and/or an RU 140), and the second network entity may include an AP 1006 associated with the second RAT (e.g., Wi-Fi). In some aspects, the AP 1006 may further include an authentication server associated with the AP. The aspects may be performed by the UE 1002 in cooperation with the base station 1004 and the AP 1006.

As shown in FIG. 10, at 1008, the AP 1006 may transmit to a UE 1002 channel information of a preferred channel for the second RAT to the base station 1004. The preferred channel provided by the AP 1006 may indicate the channels that may be used for communication using the second RAT, which helps the base station 1004 to configure one or more anchor channels for the first RAT. For example, the base station 1004 may configure one or more anchor channels so that the anchor channels do not overlap with the preferred channel.

At 1010, the base station 1004 may transmit to the UE 1002 a configuration for the allocation of one or more anchor channels for a first RAT. For example, referring to FIG. 9, the one or more anchor channels may include anchor channels 912, 914, 916, 918. In some examples, these anchor channels may be reserved for transmitting signals, such as synchronization signals, RACH messages, for the first RAT.

At 1012, the base station 1004 may provide a first BWP configuration for a first BWP of the first RAT to the UE 1002. The first BWP may include a first anchor channel of the one or more anchor channels and a first frequency space adjacent to the first anchor channel. For example, referring to FIG. 8, the first BWP 820 for the first RAT may include a first anchor channel 802 of the one or more anchor channels and a frequency space 830 adjacent to the first anchor channel 802.

At 1014, the base station 1004 may provide a second BWP configuration for a second BWP of the first RAT to the UE 1002. The second BWP may include a second anchor channel of the one or more anchor channels different from the first anchor channel and a second frequency space adjacent to the second anchor channel. For example, referring to FIG. 8, the second BWP 822 may include a second anchor channel 804 of the one or more anchor channels different from the first anchor channel and a second frequency space 840 adjacent to the second anchor channel 804.

At 1016, the base station 1004 may indicate anchor information of the one or more anchor channels to the authentication server associated with the second RAT, and the AP 1006 of the second RAT may obtain the information of the one or more anchor channels based on the anchor information from the authentication server.

At 1018, the base station 1004 may indicate the timing information for the initialization or maintenance procedure between the UE 1002 and the base station 1004 to the AP 1006. In some examples, the initialization or maintenance procedure may be performed on the one or more anchor channels. For example, the initialization or maintenance procedure may include transmitting or receiving a synchronization signal based on the first RAT, transmitting, receiving, or monitoring for a RACH message based on the first RAT, or transmitting, receiving, or monitoring for a paging signal based on the first RAT. In some examples, the timing information may include one or more of: a first periodicity of the synchronization signal, a first offset of the synchronization signal, a second periodicity of a random access occasion, a second offset of the random access occasion, a third periodicity of a paging occasion, or a third offset of the paging occasion.

At 1020, the UE 1002 and the base station 1004 may perform the initialization or maintenance procedure for the RAT using at least one anchor channel of one or more anchor channels. In some examples, the one or more anchor channels may be distributed in a frequency band shared between the first RAT and a second RAT. In some examples, the frequency band may include the upper 6 GHz band. In some examples, the frequency band may include bands lower than 6 GHz or higher than 6 GHz.

In some examples, at 1022, the UE 1002 may communicate with the AP 1006 on the frequency band using the second RAT.

In some examples, at 1024, the UE 1002 may communicate with the base station 1004 on the frequency band using the first RAT. The first RAT may have priority over the second RAT (e.g., for communication at 1022) on using the one or more anchor channels. The first RAT and the second RAT may have various prior on using the frequency band (other than the one or more anchor channels). In some examples, the first RAT (e.g., communication at 1024) may have a higher priority than the second RAT (e.g., communication at 1022) to use the frequency band. In some examples, the first RAT (e.g., communication at 1024) may have a lower priority than the second RAT (e.g., communication at 1022) to use the frequency band.

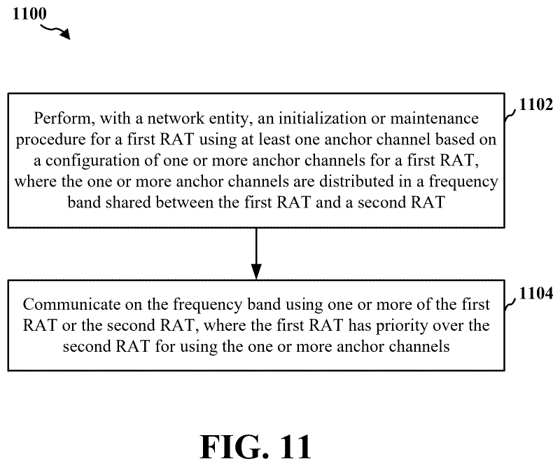

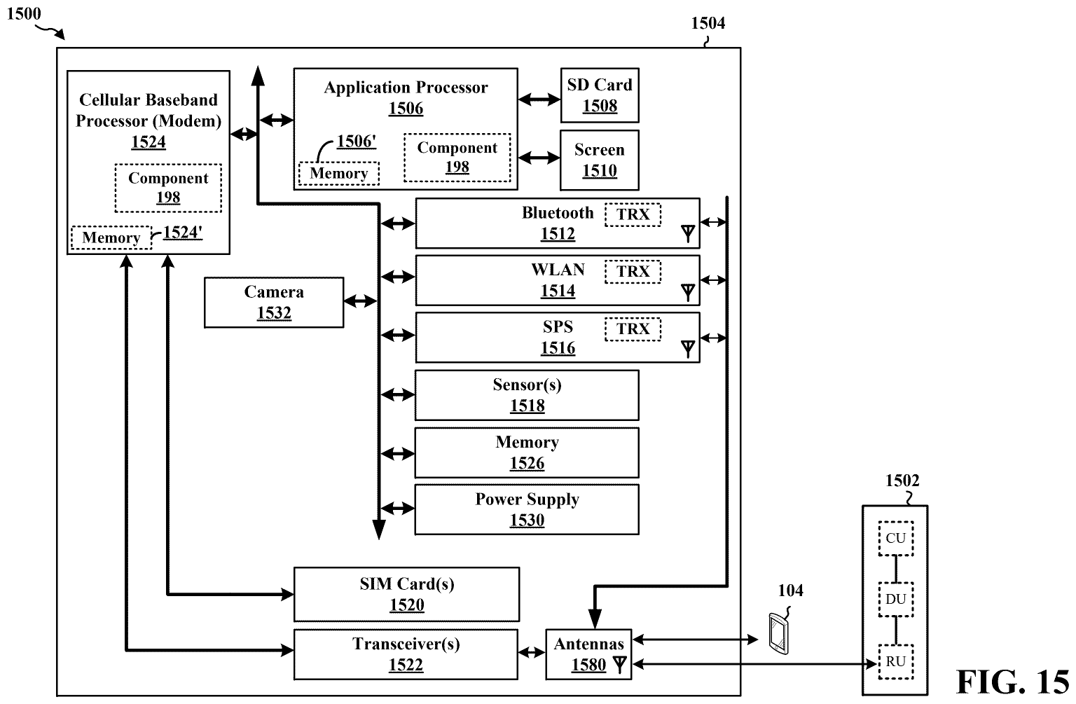

FIG. 11 is a flowchart 1100 illustrating methods of wireless communication at a UE in accordance with various aspects of the present disclosure. The method may be performed by a UE in cooperation with a network entity. The UE may be the UE 104, 350, 902, 1002, or the apparatus 1504 in the hardware implementation of FIG. 15. The network entity may be a base station, or a component of a base station, in the access network of FIG. 1 or a core network component (e.g., base station 102, 310, 904, 1004; or the network entity 1502 in the hardware implementation of FIG. 15). By designating specific channels in a frequency band, such as the upper 6 GHz band, as anchor channels, the methods ensure that important signals for one RAT, such as synchronization, RACH, and paging signals, are transmitted without interference from signals from another RAT, such as Wi-Fi, thereby improving the reliability and quality of service in wireless communication. Additionally, by structuring spectrum usage to allow different RATs to operate on adjacent or non-overlapping channels, the methods facilitate the coexistence of various RATs, such as wireless cellular communication and Wi-Fi, enhancing the overall performance of wireless communication. In some examples, by allowing for dynamic configuration of anchor channels based on real-time network conditions, the methods improve the flexibility and reliability of resource utilization in wireless communication.

As shown in FIG. 11, at 1102, the UE may perform, with the network entity, an initialization or maintenance procedure for a first RAT using at least one anchor channel based on a configuration of one or more anchor channels for the first RAT. The one or more anchor channels may be distributed in a frequency band shared between the first RAT and a second RAT. FIG. 7, FIG. 8, FIG. 9, and FIG. 10 illustrate various aspects of the steps in connection with flowchart 1100. For example, referring to FIG. 10, the UE 1002 may, at 1020, perform an initialization or maintenance procedure with the network entity (base station 1004) for a first RAT using at least one anchor channel based on a configuration of one or more anchor channels for the first RAT. Referring to FIG. 9, the one or more anchor channels (e.g., anchor channels 912, 914, 916, 918) may be distributed in a frequency band 940 shared between the first RAT and a second RAT. In some aspects, 1102 may be performed by the anchor channel component 198.

At 1104, the UE may communicate on the frequency band using one or more of the first RAT or the second RAT. The first RAT may have priority over the second RAT for using the one or more anchor channels. For example, referring to FIG. 9 and FIG. 10, the UE 1002 may, at 1024, communicate on the frequency band (e.g., 940) using one or more of the first RAT (e.g., cellular communication with base station 904) or the second RAT (e.g., Wi-Fi communication with AP 906). The first RAT may have priority over the second RAT for using the one or more anchor channels (e.g., anchor channels 912, 914, 916, 918). In some aspects, 1104 may be performed by the anchor channel component 198.

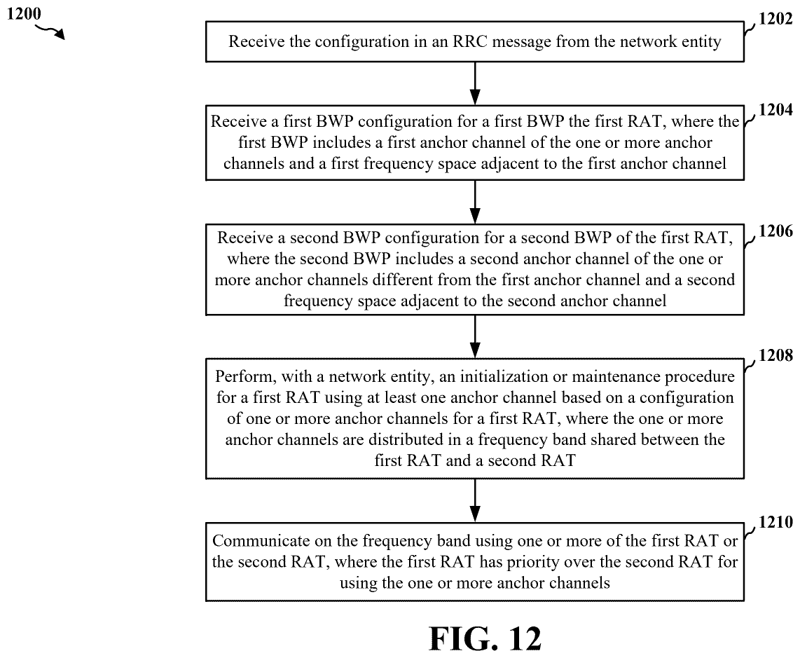

FIG. 12 is a flowchart 1200 illustrating methods of wireless communication at a UE in accordance with various aspects of the present disclosure. The method may be performed by a UE in cooperation with a network entity. The UE may be the UE 104, 350, 1002, or the apparatus 1504 in the hardware implementation of FIG. 15. The network entity may be a base station, or a component of a base station, in the access network of FIG. 1 or a core network component (e.g., base station 102, 310, 1004; or the network entity 1502 in the hardware implementation of FIG. 15). By designating specific channels in a frequency band, such as the upper 6 GHz band, as anchor channels, the methods ensure that important signals for one RAT, such as synchronization, RACH, and paging signals, are transmitted without interference from signals from another RAT, such as Wi-Fi, thereby improving the reliability and quality of service in wireless communication. Additionally, by structuring spectrum usage to allow different RATs to operate on adjacent or non-overlapping channels, the methods facilitate the coexistence of various RATs, such as wireless cellular communication and Wi-Fi, enhancing the overall performance of wireless communication. In some examples, by allowing for dynamic configuration of anchor channels based on real-time network conditions, the methods improve the flexibility and reliability of resource utilization in wireless communication.

As shown in FIG. 12, at 1208, the UE may perform, with the network entity, an initialization or maintenance procedure for the first RAT using at least one anchor channel based on a configuration of one or more anchor channels for the first RAT. The one or more anchor channels may be distributed in a frequency band shared between the first RAT and a second RAT. FIG. 7, FIG. 8, FIG. 9, and FIG. 10 illustrate various aspects of the steps in connection with flowchart 1200. For example, referring to FIG. 10, the UE 1002 may, at 1020, perform an initialization or maintenance procedure with the network entity (base station 1004) for a first RAT using at least one anchor channel based on a configuration of one or more anchor channels for the first RAT. Referring to FIG. 9, the one or more anchor channels (e.g., anchor channels 912, 914, 916, 918) may be distributed in a frequency band 940 shared between the first RAT and a second RAT. In some aspects, 1208 may be performed by the anchor channel component 198.

At 1210, the UE may communicate on the frequency band using one or more of the first RAT or the second RAT. The first RAT may have priority over the second RAT for using the one or more anchor channels. For example, referring to FIG. 9 and FIG. 10, the UE 1002 may, at 1024, communicate on the frequency band (e.g., 940) using one or more of the first RAT (e.g., cellular communication with base station 904) or the second RAT (e.g., Wi-Fi communication with AP 906). The first RAT may have priority over the second RAT for using the one or more anchor channels (e.g., anchor channels 912, 914, 916, 918). In some aspects, 1210 may be performed by the anchor channel component 198.

In some aspects, the frequency band may include a frequency of 6 GHz. For example, the frequency band may be the upper 6 GHz band. For example, referring to FIG. 7, the frequency band may span from the lower limit of 6425 MHz to the upper limit of 7125 MHz. In some aspects, the frequency band may include bands lower than 6 GHz or higher than 6 GHz.

In some aspects, the configuration may be defined in a wireless standard. In some examples, at 1202, the UE may receive the configuration of the one or more anchor channels in an RRC message from the network entity. For example, referring to FIG. 10, the UE 1002 may, at 1010, receive the configuration of the one or more anchor channels in an RRC message from the network entity (base station 1004). In some aspects, 1202 may be performed by the anchor channel component 198.

In some aspects, the one or more anchor channels may be evenly distributed on the frequency band, and each anchor channel of the one or more anchor channels may have the bandwidth equal to or greater than 20 MHz. For example, referring to FIG. 7, the one or more anchor channels (e.g., anchor channels 702, 704, 706, 708, 710, 712, 714) may be evenly distributed on the frequency band, and each anchor channel of the one or more anchor channels (e.g., anchor channels 702, 704, 706, 708, 710, 712, 714) may have the bandwidth equal to or greater than 20 MHz.

In some aspects, to perform the initialization or maintenance procedure for the first RAT (at 1208), the UE may transmit or receive a synchronization signal based on the first RAT. In some aspects, to perform the initialization or maintenance procedure for the first RAT (at 1208), the UE may transmit, receive, or monitor for a RACH message based on the first RAT. In some aspects, to perform the initialization or maintenance procedure for the first RAT (at 1208), the UE may transmit, receive, or monitor for a paging signal based on the first RAT. For example, referring to FIG. 9, the UE 902 may transmit or receive a synchronization signal, transmit, receive, or monitor for a RACH message, or transmit, receive, or monitor for a paging signal based on the first RAT (e.g., cellular communication with base station 904).

In some aspects, the first RAT is for wireless cellular communication, and the second RAT is for Wi-Fi communication, and the first RAT may have a higher priority than the second RAT to use the frequency band. For example, referring to FIG. 9, the first RAT is wireless cellular communication with base station 904, and the second RAT is for Wi-Fi communication with the AP 906, and the first RAT may have a higher priority than the second RAT to use the frequency band 940.

In some aspects, the frequency space between adjacent anchor channels of the one or more anchor channels may accommodate a Wi-Fi bonded channel. For example, referring to FIG. 8, the frequency space 830 between adjacent anchor channels (e.g., anchor channels 802, 804) may accommodate a Wi-Fi bonded channel.

In some aspects, at 1204, the UE may receive a first bandwidth part (BWP) configuration for a first BWP of the first RAT. The first BWP may include a first anchor channel of the one or more anchor channels and a first frequency space adjacent to the first anchor channel. For example, referring to FIG. 10, the UE 1002 may receive a first BWP configuration for a first BWP of the first RAT at 1012. Referring to FIG. 8, the first BWP 820 may include a first anchor channel 802 of the one or more anchor channels and a first frequency space 830 adjacent to the first anchor channel 802. In some aspects, 1204 may be performed by the anchor channel component 198.

In some aspects, at 1206, the UE may receive a second BWP configuration for a second BWP of the first RAT. The second BWP may include a second anchor channel of the one or more anchor channels different from the first anchor channel and a second frequency space adjacent to the second anchor channel. For example, referring to FIG. 10, the UE 1002 may, at 1014, receive a second BWP configuration for a second BWP of the first RAT. Referring to FIG. 8, the second BWP 822 may include a second anchor channel 804 of the one or more anchor channels different from the first anchor channel 802 and a second frequency space 840 adjacent to the second anchor channel 804. In some aspects, 1206 may be performed by the anchor channel component 198.

In some aspects, the first communication associated with the first BWP and the second communication associated with the second BWP may have a synchronous TDD or the first BWP and the second BWP are associated with the same RU. For example, referring to FIG. 8, in some examples, the first communication associated with the first BWP 820 and the second communication associated with the second BWP 822 may have a synchronous TDD. In some examples, the first BWP 820 and the second BWP 822 may be associated with the same RU.

In some aspects, a guard band may be provided between the first BWP and the second BWP. For example, referring to FIG. 7, a guard band 732 may be provided between the first BWP 724 and the second BWP 726. Referring to FIG. 9, a guard band 932 may be provided between the first BWP 920 and the second BWP 922.

In some aspects, a primary channel for the second RAT may not overlap with the one or more anchor channels. For example, referring to FIG. 9, the primary channel 954 for the second RAT may not overlap with the one or more anchor channels (e.g., anchor channels 912, 914).

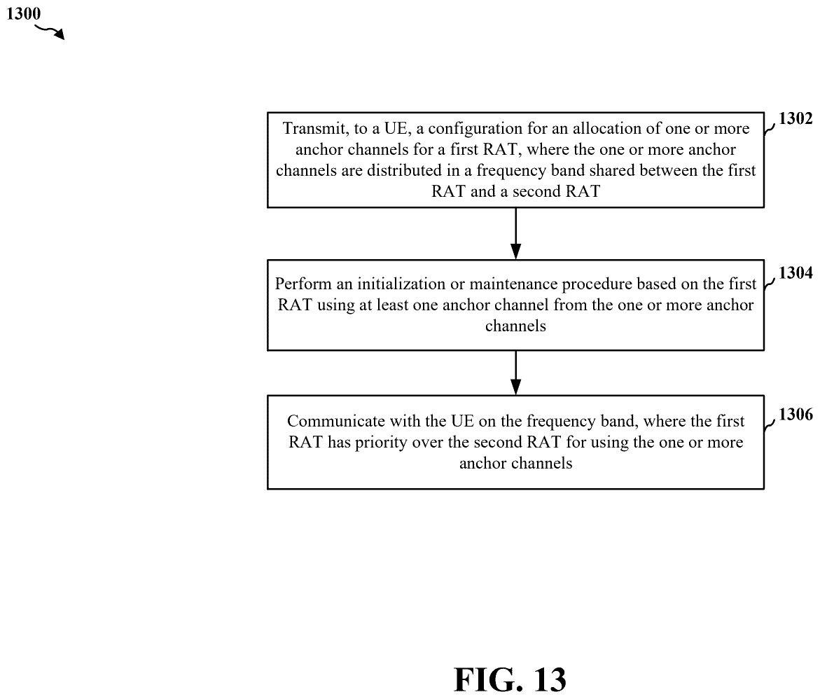

FIG. 13 is a flowchart 1300 illustrating methods of wireless communication at a network entity in accordance with various aspects of the present disclosure. The method may be performed by a network entity in cooperation with a UE. The network entity may be a base station, or a component of a base station, in the access network of FIG. 1 or a core network component (e.g., base station 102, 310, 904, 1004; or the network entity 1502 in the hardware implementation of FIG. 15). The UE may be the UE 104, 350, 902, 1002, or the apparatus 1504 in the hardware implementation of FIG. 15. By designating specific channels in a frequency band, such as the upper 6 GHz band, as anchor channels, the methods ensure that important signals for one RAT, such as synchronization, RACH, and paging signals, are transmitted without interference from signals from another RAT, such as Wi-Fi, thereby improving the reliability and quality of service in wireless communication. Additionally, by structuring spectrum usage to allow different RATs to operate on adjacent or non-overlapping channels, the methods facilitate the coexistence of various RATs, such as wireless cellular communication and Wi-Fi, enhancing the overall performance of wireless communication. In some examples, by allowing for dynamic configuration of anchor channels based on real-time network conditions, the methods improve the flexibility and reliability of resource utilization in wireless communication.

As shown in FIG. 13, at 1302, the network entity may transmit a configuration to a UE for an allocation of one or more anchor channels for a first RAT. The one or more anchor channels may be distributed in a frequency band shared between the first RAT and a second RAT. FIG. 7, FIG. 8, FIG. 9, and FIG. 10 illustrate various aspects of the steps in connection with flowchart 1300. For example, referring to FIG. 10, the network entity (base station 1004) may, at 1010, transmit a configuration to a UE 1002 for an allocation of one or more anchor channels for a first RAT. Referring to FIG. 9, the one or more anchor channels (e.g., anchor channels 912, 914, 916, 918) may be distributed in a frequency band 940 shared between the first RAT and a second RAT. In some examples, 1302 may be performed by the anchor channel component 199.

At 1304, the network entity may perform an initialization or maintenance procedure based on the first RAT using at least one anchor channel from the one or more anchor channels. For example, referring to FIG. 10, the network entity (base station 1004) may, at 1020, perform an initialization or maintenance procedure based on the first RAT using at least one anchor channel from the one or more anchor channels. In some aspects, 1304 may be performed by the anchor channel component 199.

At 1306, the network entity may communicate with the UE on the frequency band. The first RAT may have priority over the second RAT for using the one or more anchor channels. For example, referring to FIG. 9 and FIG. 10, the network entity (base station 1004) may, at 1024, communicate with the UE 1002 on the frequency band 940. The first RAT may have priority over the second RAT for using the one or more anchor channels (e.g., anchor channels 912, 914, 916, 918). In some aspects, 1306 may be performed by the anchor channel component 199.

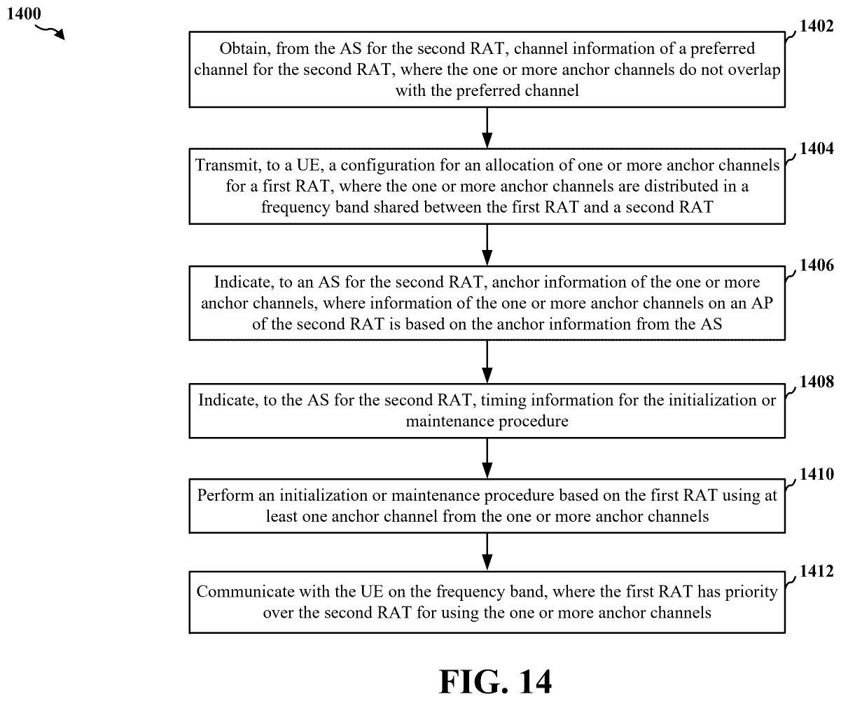

FIG. 14 is a flowchart 1400 illustrating methods of wireless communication at a network entity in accordance with various aspects of the present disclosure. The method may be performed by a network entity in cooperation with a UE. The network entity may be a base station, or a component of a base station, in the access network of FIG. 1 or a core network component (e.g., base station 102, 310, 904, 1004; or the network entity 1502 in the hardware implementation of FIG. 15). The UE may be the UE 104, 350, 902, 1002, or the apparatus 1504 in the hardware implementation of FIG. 15. By designating specific channels in a frequency band, such as the upper 6 GHz band, as anchor channels, the methods ensure that important signals for one RAT, such as synchronization, RACH, and paging signals, are transmitted without interference from signals from another RAT, such as Wi-Fi, thereby improving the reliability and quality of service in wireless communication. Additionally, by structuring spectrum usage to allow different RATs to operate on adjacent or non-overlapping channels, the methods facilitate the coexistence of various RATs, such as wireless cellular communication and Wi-Fi, enhancing the overall performance of wireless communication. In some examples, by allowing for dynamic configuration of anchor channels based on real-time network conditions, the methods improve the flexibility and reliability of resource utilization in wireless communication.

As shown in FIG. 14, at 1404, the network entity may transmit a configuration to a UE for an allocation of one or more anchor channels for a first RAT. The one or more anchor channels may be distributed in a frequency band shared between the first RAT and a second RAT. FIG. 7, FIG. 8, FIG. 9, and FIG. 10 illustrate various aspects of the steps in connection with flowchart 1400. For example, referring to FIG. 10, the network entity (base station 1004) may, at 1010, transmit a configuration to a UE 1002 for an allocation of one or more anchor channels for a first RAT. Referring to FIG. 9, the one or more anchor channels (e.g., anchor channels 912, 914, 916, 918) may be distributed in a frequency band 940 shared between the first RAT and a second RAT. In some examples, 1404 may be performed by the anchor channel component 199.

At 1410, the network entity may perform an initialization or maintenance procedure based on the first RAT using at least one anchor channel from the one or more anchor channels. For example, referring to FIG. 10, the network entity (base station 1004) may, at 1020, perform an initialization or maintenance procedure based on the first RAT using at least one anchor channel from the one or more anchor channels. In some aspects, 1410 may be performed by the anchor channel component 199.

At 1412, the network entity may communicate with the UE on the frequency band. The first RAT may have priority over the second RAT for using the one or more anchor channels. For example, referring to FIG. 9 and FIG. 10, the network entity (base station 1004) may, at 1024, communicate with the UE 1002 on the frequency band 940. The first RAT may have priority over the second RAT for using the one or more anchor channels (e.g., anchor channels 912, 914, 916, 918). In some aspects, 1412 may be performed by the anchor channel component 199.

In some aspects, to perform the initialization or maintenance procedure for the first RAT using the at least one anchor channel (at 1410), the network entity may receive or transmit a synchronization signal for the first RAT. In some aspects, to perform the initialization or maintenance procedure for the first RAT using the at least one anchor channel (at 1410), the network entity may receive or transmit a RACH message for the first RAT. In some aspects, to perform the initialization or maintenance procedure for the first RAT using the at least one anchor channel (at 1410), the network entity may receive or transmit a paging signal for the first RAT. For example, referring to FIG. 9, the network entity (e.g., base station 904) may receive or transmit a synchronization signal for the first RAT (e.g., cellular communication with UE 902), receive or transmit a RACH message for the first RAT (e.g., cellular communication with UE 902), or receive or transmit a paging signal for the first RAT (e.g., cellular communication with UE 902).

In some aspects, the first RAT is for wireless cellular communication, and the second RAT is for Wi-Fi communication, and the first RAT may have a higher priority than the second RAT for using the frequency band than the second RAT. For example, referring to FIG. 9, the first RAT is wireless cellular communication with UE 902, and the second RAT is Wi-Fi communication at 922, and the first RAT may have a higher priority than the second RAT to use the frequency band 940.

In some aspects, at 1406, the network entity may indicate, to an AS for the second RAT, anchor information of the one or more anchor channels. The information of the one or more anchor channels on an AP of the second RAT may be based on the anchor information from the AS. For example, referring to FIG. 10, the network entity (base station 1004) may, at 1016, indicate anchor information of the one or more anchor channels. The information of the one or more anchor channels on the AP 1006 of the second RAT may be based on the anchor information. In some aspects, 1406 may be performed by the anchor channel component 199.

In some aspects, the first RAT is for wireless cellular communication, and the second RAT is for Wi-Fi communication, and the first RAT may have a lower priority than the second RAT for using the frequency band than the second RAT. For example, referring to FIG. 9, the first RAT is for wireless cellular communication on 920, and the second RAT is for Wi-Fi communication on 922, and the first RAT may have a lower priority than the second RAT for using the frequency band 940 than the second RAT.

In some aspects, at 1402, the network entity may obtain, from an AS for the second RAT, channel information of a preferred channel for the second RAT. The one or more anchor channels do not overlap with the preferred channel. For example, referring to FIG. 10, the network entity (base station 1004) may obtain, at 1008, channel information of a preferred channel for the second RAT. The one or more anchor channels do not overlap with the preferred channel. In some aspects, 1402 may be performed by the anchor channel component 199.

In some aspects, at 1408, the network entity may indicate timing information for the initialization or maintenance procedure to an AS for the second RAT. The timing information may include one or more of: a first periodicity of the synchronization signal, a first offset of the synchronization signal, a second periodicity of a random access occasion, a second offset of the random access occasion, a third periodicity of a paging occasion, or a third offset of the paging occasion. For example, referring to FIG. 10, the network entity (base station 1004) may, at 1018, indicate timing information for the initialization or maintenance procedure. The timing information may include one or more of: a first periodicity of the synchronization signal, a first offset of the synchronization signal, a second periodicity of a random access occasion, a second offset of the random access occasion, a third periodicity of a paging occasion, or a third offset of the paging occasion. In some aspects, 1408 may be performed by the anchor channel component 199.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to perform, with a network entity, an initialization or maintenance procedure for a first RAT using at least one anchor channel based on a configuration of one or more anchor channels for the first RAT, where the one or more anchor channels are distributed in a frequency band shared between the first RAT and a second RAT; and communicate on the frequency band using one or more of the first RAT or the second RAT, where the first RAT has priority over the second RAT for using the one or more anchor channels. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for performing, with a network entity, an initialization or maintenance procedure for a first RAT using at least one anchor channel based on a configuration of one or more anchor channels for the first RAT, where the one or more anchor channels are distributed in a frequency band shared between the first RAT and a second RAT, and means for communicating on the frequency band using one or more of the first RAT or the second RAT, where the first RAT has priority over the second RAT for using the one or more anchor channels. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

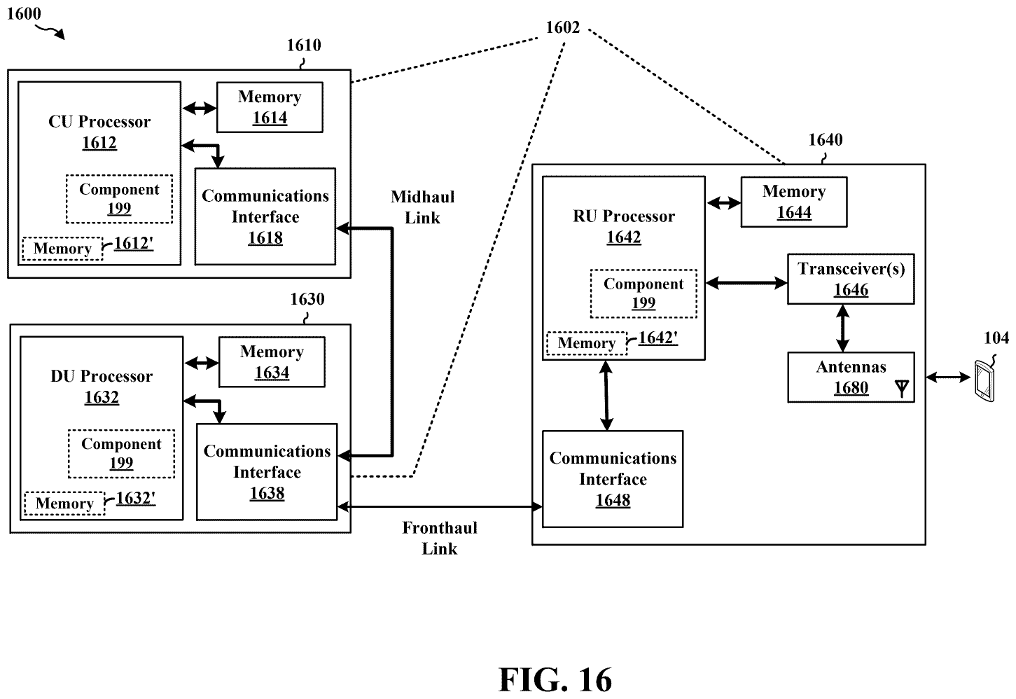

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, a configuration for an allocation of one or more anchor channels for a first RAT, where the one or more anchor channels are distributed in a frequency band shared between the first RAT and a second RAT; perform an initialization or maintenance procedure based on the first RAT using at least one anchor channel from the one or more anchor channels; and communicate with the UE on the frequency band, wherein the first RAT has priority over the second RAT for using the one or more anchor channels. The component 199 may be further configured to perform any of the aspects described in connection with the flowcharts in FIG. 13 and FIG. 14, and/or performed by the base station 1004 in FIG. 10. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for transmitting, to a UE, a configuration for an allocation of one or more anchor channels for a first RAT, where the one or more anchor channels are distributed in a frequency band shared between the first RAT and a second RAT, means for performing an initialization or maintenance procedure based on the first RAT using at least one anchor channel from the one or more anchor channels, and means for communicating with the UE on the frequency band, wherein the first RAT has priority over the second RAT for using the one or more anchor channels. The network entity 1602 may further include means for performing any of the aspects described in connection with the flowcharts in FIG. 13 and FIG. 14, and/or aspects performed by the base station 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include performing, with a network entity, an initialization or maintenance procedure for a first radio access technology (RAT) using at least one anchor channel based on a configuration of one or more anchor channels for the first RAT, where the one or more anchor channels are distributed in a frequency band shared between the first RAT and a second RAT; and communicating on the frequency band using one or more of the first RAT or the second RAT. The first RAT may have priority over the second RAT for using the one or more anchor channels. By designating specific channels in a frequency band, such as the upper 6 GHz band, as anchor channels, the methods ensure that important signals for one RAT, such as synchronization, RACH, and paging signals, are transmitted without interference from signals from another RAT, such as Wi-Fi, thereby improving the reliability and quality of service in wireless communication. Additionally, by structuring spectrum usage to allow different RATs to operate on adjacent or non-overlapping channels, the methods facilitate the coexistence of various RATs, such as wireless cellular communication and Wi-Fi, enhancing the overall performance of wireless communication. In some examples, by allowing for dynamic configuration of anchor channels based on real-time network conditions, the methods improve the flexibility and reliability of resource utilization in wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes performing, with a network entity, an initialization or maintenance procedure for a first radio access technology (RAT) using at least one anchor channel based on a configuration of one or more anchor channels for the first RAT, wherein the one or more anchor channels are distributed in a frequency band shared between the first RAT and a second RAT; and communicating on the frequency band using one or more of the first RAT or the second RAT, wherein the first RAT has priority over the second RAT for using the one or more anchor channels.

Aspect 2 is the method of aspect 1, wherein the frequency band comprises a frequency of 6 GHz.

Aspect 3 is the method of any of aspects 1 to 2, wherein the configuration is defined in a wireless standard, or wherein the method further includes receiving the configuration of the one or more anchor channels in a radio resource control (RRC) message from the network entity.

Aspect 4 is the method of any of aspects 1 to 3, wherein the one or more anchor channels are evenly distributed on the frequency band, and each anchor channel of the one or more anchor channels has a bandwidth equal to or greater than 20 MHZ.

Aspect 5 is the method of any of aspects 1 to 4, wherein performing the initialization or maintenance procedure for the first RAT using the at least one anchor channel includes: transmitting or receiving a synchronization signal based on the first RAT, transmitting, receiving, or monitoring for a random access channel (RACH) message based on the first RAT, or transmitting, receiving, or monitoring for a paging signal based on the first RAT.

Aspect 6 is the method of any of aspects 1 to 5, wherein the first RAT is for wireless cellular communication, and the second RAT is for Wi-Fi communication, and wherein the first RAT has a higher priority than the second RAT to use the frequency band.

Aspect 7 is the method of aspect 6, wherein a frequency space between adjacent anchor channels of the one or more anchor channels accommodates a Wi-Fi bonded channel.

Aspect 8 is the method of aspect 6, where the method further includes receiving a first bandwidth part (BWP) configuration for a first BWP of the first RAT, wherein the first BWP includes a first anchor channel of the one or more anchor channels and a first frequency space adjacent to the first anchor channel.

Aspect 9 is the method of aspect 8, where the method further includes receiving a second BWP configuration for a second BWP of the first RAT, wherein the second BWP includes a second anchor channel of the one or more anchor channels different from the first anchor channel and a second frequency space adjacent to the second anchor channel.

Aspect 10 is the method of aspect 9, wherein first communication associated with the first BWP and second communication associated with the second BWP have a synchronous time division duplex (TDD) or the first BWP and the second BWP are associated with a same resource unit (RU).

Aspect 11 is the method of aspect 9, wherein a guard band is provided between the first BWP and the second BWP.

Aspect 12 is the method of any of aspects 1 to 6, wherein a primary channel for the second RAT does not overlap with the one or more anchor channels.

Aspect 13 is an apparatus for wireless communication at a UE, comprising: a processing system that includes processor circuitry and memory circuitry that stores code and is coupled with the processor circuitry, the processing system configured to cause the UE to perform the method of one or more of aspects 1-12.

Aspect 14 is an apparatus for wireless communication at a UE, comprising: at least one memory; and at least one processor coupled to the at least one memory and, where the at least one processor, individually or in any combination, is configured to perform the method of any of aspects 1-12.

Aspect 15 is the apparatus for wireless communication at a UE, comprising means for performing each step in the method of any of aspects 1-12.

Aspect 16 is an apparatus of any of aspects 13-15, further comprising a transceiver configured to receive or to transmit in association with the method of any of aspects 1-12.

Aspect 17 is a computer-readable medium (e.g., a non-transitory computer-readable medium) storing computer executable code at a UE, the code when executed by at least one processor causes the at least one processor to, individually or in any combination, perform the method of any of aspects 1-12.

Aspect 18 is a method of wireless communication at a network entity. The method includes transmitting, to a user equipment (UE), a configuration for an allocation of one or more anchor channels for a first radio access technology (RAT), wherein the one or more anchor channels are distributed in a frequency band shared between the first RAT and a second RAT; performing an initialization or maintenance procedure based on the first RAT using at least one anchor channel from the one or more anchor channels; and communicating with the UE on the frequency band, wherein the first RAT has priority over the second RAT for using the one or more anchor channels.

Aspect 19 is the method of aspect 18, wherein performing the initialization or maintenance procedure for the first RAT using the at least one anchor channel includes receiving or transmitting a synchronization signal for the first RAT, receiving or transmitting a random access channel (RACH) message for the first RAT, or receiving or transmitting a paging signal for the first RAT.

Aspect 20 is the method of any of aspects 18 to 19, wherein the first RAT is for wireless cellular communication, and the second RAT is for Wi-Fi communication, and wherein the first RAT has a higher priority than the second RAT for using the frequency band than the second RAT.

Aspect 21 is the method of aspect 20, where the method further includes indicating, to an authentication server (AS) for the second RAT, anchor information of the one or more anchor channels, wherein information of the one or more anchor channels on an access point (AP) of the second RAT is based on the anchor information from the AS.

Aspect 22 is the method of any of aspects 18 to 19, wherein the first RAT is for wireless cellular communication, and the second RAT is for Wi-Fi communication, and wherein the first RAT has a lower priority than the second RAT for using the frequency band than the second RAT.

Aspect 23 is the method of aspect 22, where the method further includes, before transmitting the configuration for the allocation: obtaining, from an authentication server (AS) for the second RAT, channel information of a preferred channel for the second RAT, wherein the one or more anchor channels do not overlap with the preferred channel.

Aspect 24 is the method of any of aspects 18 to 19, where the method further includes indicating, to an authentication server (AS) for the second RAT, timing information for the initialization or maintenance procedure, wherein the timing information includes one or more of: a first periodicity of the synchronization signal, a first offset of the synchronization signal, a second periodicity of a random access occasion, a second offset of the random access occasion, a third periodicity of a paging occasion, or a third offset of the paging occasion.

Aspect 25 is an apparatus for wireless communication at a network entity, comprising: a processing system that includes processor circuitry and memory circuitry that stores code and is coupled with the processor circuitry, the processing system configured to cause the network entity to perform the method of one or more of aspects 18-24.

Aspect 26 is an apparatus for wireless communication at a network entity, comprising: at least one memory; and at least one processor coupled to the at least one memory and, where the at least one processor, individually or in any combination, is configured to perform the method of any of aspects 18-24.

Aspect 27 is the apparatus for wireless communication at a network entity, comprising means for performing each step in the method of any of aspects 18-24.

Aspect 28 is an apparatus of any of aspects 25-27, further comprising a transceiver configured to receive or to transmit in association with the method of any of aspects 18-24.

Aspect 29 is a computer-readable medium (e.g., a non-transitory computer-readable medium) storing computer executable code at a network entity, the code when executed by at least one processor causes the at least one processor to, individually or in any combination, perform the method of any of aspects 18-24.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
perform, with a network entity, an initialization or maintenance procedure for a first radio access technology (RAT) using at least one anchor channel based on a configuration of one or more anchor channels for the first RAT, wherein the one or more anchor channels are distributed in a frequency band shared between the first RAT and a second RAT; and
communicate on the frequency band using one or more of the first RAT or the second RAT, wherein the first RAT has priority over the second RAT for using the one or more anchor channels.

2. The apparatus of claim 1, further comprising a transceiver coupled to the at least one processor, wherein to communicate on the frequency band using one or more of the first RAT or the second RAT, the at least one processor, individually or in any combination, is configured to cause the UE to communicate on the frequency band using one or more of the first RAT or the second RAT via the transceiver, and wherein the frequency band comprises a frequency of 6 GHz.

3. The apparatus of claim 1, wherein the configuration is defined in a wireless standard, or wherein the at least one processor, individually or in any combination, is further configured to cause the UE to:
receive the configuration of the one or more anchor channels in a radio resource control (RRC) message from the network entity.

4. The apparatus of claim 1, wherein the one or more anchor channels are evenly distributed on the frequency band, and each anchor channel of the one or more anchor channels has a bandwidth equal to or greater than 20 MHZ.

5. The apparatus of claim 1, wherein to perform the initialization or maintenance procedure for the first RAT using the at least one anchor channel, the at least one processor, individually or in any combination, is configured to cause the UE to:
transmit or receive a synchronization signal based on the first RAT,
transmit, receive, or monitor for a random access channel (RACH) message based on the first RAT, or
transmit, receive, or monitor for a paging signal based on the first RAT.

6. The apparatus of claim 1, wherein the first RAT is for wireless cellular communication, and the second RAT is for Wi-Fi communication, and wherein the first RAT has a higher priority than the second RAT to use the frequency band.

7. The apparatus of claim 6, wherein a frequency space between adjacent anchor channels of the one or more anchor channels accommodates a Wi-Fi bonded channel.

8. The apparatus of claim 6, wherein the at least one processor, individually or in any combination, is further configured to cause the UE to:
receive a first bandwidth part (BWP) configuration for a first BWP of the first RAT, wherein the first BWP includes a first anchor channel of the one or more anchor channels and a first frequency space adjacent to the first anchor channel.

9. The apparatus of claim 8, wherein the at least one processor, individually or in any combination, is further configured to cause the UE to:
receive a second BWP configuration for a second BWP of the first RAT, wherein the second BWP includes a second anchor channel of the one or more anchor channels different from the first anchor channel and a second frequency space adjacent to the second anchor channel.

10. The apparatus of claim 9, wherein first communication associated with the first BWP and second communication associated with the second BWP have a synchronous time division duplex (TDD) or the first BWP and the second BWP are associated with a same resource unit (RU).

11. The apparatus of claim 9, wherein a guard band is provided between the first BWP and the second BWP.

12. The apparatus of claim 6, wherein a primary channel for the second RAT does not overlap with the one or more anchor channels.

13. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
transmit, to a user equipment (UE), a configuration for an allocation of one or more anchor channels for a first radio access technology (RAT), wherein the one or more anchor channels are distributed in a frequency band shared between the first RAT and a second RAT;
perform an initialization or maintenance procedure based on the first RAT using at least one anchor channel from the one or more anchor channels; and
communicate with the UE on the frequency band, wherein the first RAT has priority over the second RAT for using the one or more anchor channels.

14. The apparatus of claim 13, further comprising a transceiver coupled to the at least one processor, wherein to transmit the configuration, the at least one processor, individually or in any combination, is configured to cause the network entity to transmit the configuration via the transceiver, and wherein to perform the initialization or maintenance procedure for the first RAT using the at least one anchor channel, the at least one processor, individually or in any combination, is configured to cause the network entity to:
receive or transmit a synchronization signal for the first RAT,
receive or transmit a random access channel (RACH) message for the first RAT, or
receive or transmit a paging signal for the first RAT.

15. The apparatus of claim 14, wherein the first RAT is for wireless cellular communication, and the second RAT is for Wi-Fi communication, and wherein the first RAT has a higher priority than the second RAT for using the frequency band than the second RAT.

16. The apparatus of claim 15, wherein the at least one processor, individually or in any combination, is further configured to cause the network entity to:
indicate, to an authentication server (AS) for the second RAT, anchor information of the one or more anchor channels, wherein information of the one or more anchor channels on an access point (AP) of the second RAT is based on the anchor information from the AS.

17. The apparatus of claim 14, wherein the first RAT is for wireless cellular communication, and the second RAT is for Wi-Fi communication, and wherein the first RAT has a lower priority than the second RAT for using the frequency band than the second RAT.

18. The apparatus of claim 17, wherein the at least one processor, individually or in any combination, is further configured to cause the network entity to, prior to being configured to transmit the configuration for the allocation:
obtain, from an authentication server (AS) for the second RAT, channel information of a preferred channel for the second RAT, wherein the one or more anchor channels do not overlap with the preferred channel.

19. The apparatus of claim 14, wherein the at least one processor, individually or in any combination, is further configured to cause the network entity to:
indicate, to an authentication server (AS) for the second RAT, timing information for the initialization or maintenance procedure, wherein the timing information includes one or more of:
a first periodicity of the synchronization signal,
a first offset of the synchronization signal,
a second periodicity of a random access occasion,
a second offset of the random access occasion,
a third periodicity of a paging occasion, or
a third offset of the paging occasion.

20. A method of wireless communication at a user equipment (UE), comprising:
performing, with a network entity, an initialization or maintenance procedure for a first radio access technology (RAT) using at least one anchor channel based on a configuration of one or more anchor channels for the first RAT, wherein the one or more anchor channels are distributed in a frequency band shared between the first RAT and a second RAT; and
communicating on the frequency band using one or more of the first RAT or the second RAT, wherein the first RAT has priority over the second RAT for using the one or more anchor channels.
